(19) United States
(12) Patent Application Publication
(10) Pub. No.: US 2025/0164070 A1
(43) Pub. Date: May 22, 2025

(54) UNLOCKING SYSTEM, LOCKING/UNLOCKING UNIT AND OPERATION METHOD OF THE UNLOCKING SYSTEM

(71) Applicant: Pizzato Elettrica S.R.L., Marostica, Vicenza (IT)

(72) Inventor: Giuseppe PIZZATO, Marostica, Vicenza (IT)

(21) Appl. No.: 18/837,141

(22) PCT Filed: Jan. 18, 2023
(86) PCT No.: PCT/IT2023/050015

§ 371 Date: Aug. 8, 2024

(30) Foreign Application Priority Data
Feb. 11, 2022 (IT) 102022000002546

(51) Int. Cl. F16P 3/08; F16P 3/14

(52) U.S. Cl. CPC F16P 3/08; F16P 3/147

(57) ABSTRACT

The present disclosure relates to an Unlocking system for unlocking the opening of a door or gate, a protection or the like, comprising: at least one power supply control device, interposed between a power supply network and a load to be supplied; an unlocking unit, having an actuator, comprising a body that can be fixed to a door or gate, and an engagement member, and an actuation unit, which can be fixed to a frame in correspondence with an opening, closed by said door or gate, wherein said actuation unit comprises a blocking member, engageable with said engagement member when said door or gate are closed, and a logic control unit, configured or configurable to control the operation of said at least one power supply control device, so as to allowing the interruption of the power supply of said load, and activating the blocking member, releasing the engagement member, after a predefined or predefined time interval.

### CROSS-REFERENCE TO RELATED APPLICATIONS

This application is the U.S. National Phase under 35 U.S.C. §371 of International Application PCT/IT2023/050015, filed Jan. 18, 2023, which claims priority to IT patent application Ser. No. 10/202,2000002546, filed on Feb. 11, 2022, the contents of each of which are incorporated herein by reference in its entirety.

### FIELD

The present disclosure relates to an unlocking system, locking/unlocking units and operating method of the unlocking system.

In more detail, the disclosure relates to an unlocking system designed and manufactured in particular for controlling the access to industrial plants by an operator, but which can be used for any situation in which it is necessary to protect operators from the risk of approaching a hazardous area, such as sources of radiation generation, or chemical reaction areas.

In the following, the description will be aimed at protecting the access of an industrial plant or machine, but it is clear that the same should not be considered limited to this specific use.

### BACKGROUND

Industrial machines are known, in which the stop of the machine is required only when the danger to a possible operator is no longer present. Therefore, these machines can be accessed by operators only after a certain amount of time, generally selected to allow for a complete machine stop. This is necessary, for example, due to mechanical inertia (flywheels, centrifuges, and the like), or physical variables (temperature, pressure reduction, switching off of radiant sources, etc.).

The safe stop time of the machine can also be variable or fixed. In a machine or system in general with a fixed stopping time, the traditional control circuit or system provides that the stop signal (generated by means of a button) releases a device, which keeps the dangerous part of the machine powered (e.g., the contactor or module and contactor or relay), and only after a certain time interval does a safety timer (timed module) generate a signal that unlocks the door (i.e., the switch with lock).

To overcome the problems described, it would be necessary to introduce a system for detecting the stop signal and the timing within the switch with lock.

However, electromechanical lockout switches, usually integrated, are expensive and often do not have a safety feedback.

As far as costs are concerned, as mentioned, it is generally necessary to insert a safety timer within a switch with an electromechanical lock. This often involves the need to redesign the entire circuit to take into account the overall dimensions and, therefore, an appreciable economic advantage is not achieved.

With regards to the typical lack of feedback, the control system must, as a general requirement, be able to activate the timing process only after being sure that the machine or plant has actually initiated the shutdown process. Therefore, it is not sufficient to activate the timer with the same button that starts the stop step, but it is necessary to have a feedback signal from the contactor, which indicates that the power supply has been disconnected. Otherwise, there is a risk that the timing starts before the machine has started the stop step.

Therefore, not only a safe timing system is required, but also a system for detecting that the machine stop step has started. It is very complicated to obtain these objects with an electromechanical system.

In addition, in the safety systems according to the prior art, bolts are applied, having engagement members with specific shapes, as if they were keys, such that, in case of replacement of said engagement members, the new members cannot engage and then close the machine gate or protection door.

However, very often such systems, which are mainly mechanical, can be easily modified or adapted. This implies that, as happened in the past, in some cases the safety systems, and in particular the closing engagement members, can be tampered, allowing the closing and opening of the protective door or gate in an unsafe manner and properly controlled.

### SUMMARY

In light of the above, it is, therefore, an object of the present embodiment to propose a release system capable of overcoming the limitations of those of the prior art.

It is also an object of the present embodiment to propose a unit with blocking functions equipped with onboard electronics, which is also convenient, especially if it has to be installed in small-sized machinery or plants.

Another object of the present embodiment is to introduce a delay system inside the switch.

It is also an object of the present embodiment to propose a unit that cannot be tampered, and/or such that in case of attempted tampering, it does not allow the gates or doors to be closed, also inhibiting the operation and activation of the machine or the system to limit access of.

A further object of the present embodiment is to propose an operating method of the above-mentioned unlocking unit.

It is, therefore, a specific object of the present embodiment an unlocking system as defined in claim 1.

Preferred embodiments are defined in the dependent claims.

### BRIEF DESCRIPTION OF FIGURES

The present embodiment will be now described, for illustrative but not limitative purposes, according to its preferred embodiments, with particular reference to the figures of the enclosed drawings, wherein:

FIG. 1 shows a block diagram of the unlocking unit applied to a machine;

FIG. 2 shows a protective cabin of a working plant with the door closed, to which the release unlocking system according to the embodiment is applied;

FIG. 3 shows a protective cabin of a working plant with the door open, to which the unlocking system according to the embodiment is applied;

FIG. 4 shows a possible door of the safety cabin to which the unlocking system according to the embodiment is applied;

FIG. 5 shows a detail of FIG. 4;

FIG. 6 shows a front view of the release unit of the unlocking system according to the embodiment;

FIG. 7 shows a side view of the release unit of the unlocking system according to the embodiment;

FIG. 8 shows a side view of the unlocking unit of the unlocking system according to the embodiment, in which an actuator is separated from the actuation unit;

FIG. 9 shows a front view of the actuation unit; and

FIG. 10 shows a section along section line A-A of the actuation unit of FIG. 9.

### DETAILED DESCRIPTIONS

In the various figures, similar parts will be indicated with the same reference numbers.

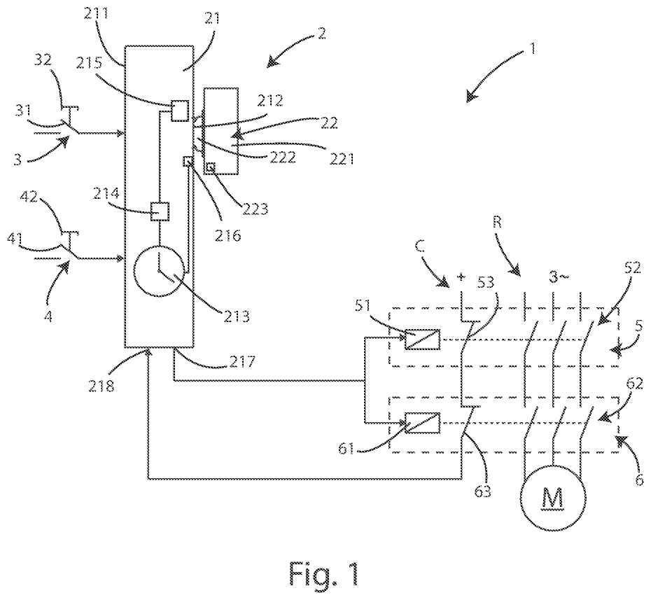

With reference to the attached FIG. 1, an unlocking system 1 according to the present embodiment can be observed.

The unlocking system 1 essentially comprises an unlocking unit 2, a start switch 3, a stop switch 4, at least a first contactor 5 (or in general a power control device), connected to the power supply network R, and a second contactor 6 (or generally a power supply control device), connected to a machine or plant M.

In some embodiments, the first 5 and/or the second 6 contactor can be replaced by other electronic switching devices, such as OSSD devices (Output Signal Switching Device), which can be advantageously positioned inside the actuation unit 21, i.e., a non-contact protective device, which can be connected to a control system, and which is capable of carrying out electrical switching.

The unlocking unit 2 comprises an actuation unit 21 and an actuator or bolt 22, capable of engaging in a removable way with said actuation unit 21.

Said actuation unit 21 has a casing or containment body 211, which can be fixed to a frame (not shown in FIG. 1) at the closure of an opening, gate, or door to be controlled or unlocked if necessary, for access by a user to the machine or system M. The containment casing 211 has an opening 212, the function of which will be better described below, in correspondence with which an electromechanical bolt, or in general a blocking member 215, is arranged.

Said actuation unit 21 also comprises a logic control unit 213, provided with an integrated and programmable solid-state timer.

Said control logic unit 213 is electronic and can be, as mentioned, suitably programmable. In particular, said logic control unit 213 can be a microprocessor, a PLC (Programmable Logic Control), a microcontroller or ASIC (Application Specific Integrated Circuit), or the like.

Said control logic unit 213 can be contained inside the containment casing 211.

In particular, said actuation unit 21 comprises the containment casing 211, in which the blocking member 215 and the logic control unit 213 are contained.

Furthermore, the drive unit 21 also comprises an actuator 214, preferably an electromagnet, and a solid-state device, such as a MOSFET (Metal-Oxide-Semiconductor Field-Effect Transistor) or an IGBT (Insulated-Gate Bipolar transistor), for controlling the blocking device 215. The actuator 214 is connected and controlled by said control logic unit 213.

Finally, an RFID (Radio Frequency Identification Device) reader 216 is arranged at said opening 212, the function of which will be better explained below.

Said start 3 and stop 4 switches are electrically connected to corresponding inputs of said actuation unit 21. In particular, said start 3 and stop 4 switches are functionally connected to said logic control unit 213. The start switches 3 and stop switches 4 each comprise a switch or contact unit for switching, respectively indicated by 31 and 41, and a button, indicated by 32 and 42, for controlling the respective switches 31 and 41.

The actuator 22 comprises a body 221 and an engagement member 222, fixed to the body 221. An RFID tag 223 is arranged in the body 221. The tag 223 is programmable and is unique, i.e., it can be uniquely associated with the bolt 22. This means that, changing or replacing the bolt, cannot functionally communicate with the RF reader 216 and therefore the gate cannot be locked by means of the of blocking member 215 and the plant be started.

In some embodiments, the positions of the tag 223 and its associated antenna may be reversed with each other. Furthermore, in other embodiments, instead of the tag 223, it is possible to provide a generic electronic communication or transceiver and recognition device, such as sensors of the magnetic or electromagnetic, optical, Hall effect type.

The actuator 22, and in particular the body 221, can be fixed to the gate or door of an opening, in general, to be closed on the frame. The actuator 22 is capable of assuming a closed position, in which the engagement member 222 is inserted in said opening 212, so as to engage, when activated, with the blocking member 215 and the tag 223 is arranged at the RFID reader, so that it can be read by it, and an open position, in which it is withdrawn or not inserted into the opening 212.

The at least one first contactor 5 has at its input a network R and a control power supply C, which can be alternating or direct. On the other hand, the second contactor 6 has the output of the first contactor 5 as its input, and the machine or system to be powered M as its output.

The power supply can be of different types, for example, but not limited to, three-phase as the one shown in the present embodiment. In any case, other types of power supplies can also be considered, to which the present embodiment can be applied.

Each contactor 5 and 6 naturally comprises a winding respectively indicated with the reference numbers 51 and 61, a group of energy switches, for switching the power supply, respectively indicated with 52 and 62, and, finally, two control switches, for switching the control power supply C, again respectively indicated with the reference numbers 53 and 63 for the first contactor 5 and for the second contactor 6.

The windings 51 and 61 of said first 5 and second 6 contactors are connected to output terminals 217 of the logic control unit 213 of the actuation unit 21.

The switch 63 is also connected as a feedback signal to the control logic unit 213 of the drive unit 21 via a feedback terminal 218.

The unlocking system 1 described above operates as follows.

When it is necessary to activate the machine or system M, the user can press the button 32, so as to close the switch 31 of the start switch 3. In this case, only if the engagement member 222 is inserted in said opening 212, i.e., if the gate or door is in a closed position, then the RFID reader 216 verifies that the tag 223 is the correct one, and if the latter is recognized, an activation signal is provided to the logic unit control 213, which can thus operate the blocking member 215 by means of the actuator 214, which therefore blocks the engagement member 222.

Only in this case can the machine or plant M (i.e., the load) be activated, and for this purpose, the control logic unit 213 transmits an activation signal via the output terminals 217 to the windings 51 and 61 of said first 5 and second 6 contactor. Then, the first 52 and second 62 groups of energy switches for switching the power supply, and the two control switches 53 and 63, are closed. In this way, the feedback signal is generated, which reaches the control logic unit 213 through the feedback terminal 218, so that it acquires the information that the machine or system M is actually powered.

When it is necessary to deactivate the machine or system M and to allow a user to access it by opening the door or gate on which the actuator 22 is installed, the user presses the button 42 of the stop switch 4 of the switch 41.

The control logic unit 213 immediately switches off the safe outputs via the terminals 217, cutting off power to the windings 51 and 61 of the first 5 and second 6 remote switches respectively. This causes the opening of the first 52 and second 62 energy switches groups, interrupting the power supply of the machine and of the plant M, and opening the two control switches 53 and 63, so that the control logic unit can detect the relevant signal on the feedback terminal 218.

Therefore, the logic control unit 213 starts the timer, specifically programmed to allow the stop of the machine or plant M.

In some embodiments, the internal and integrated timing in the control logic unit 213 can be programmable at the software level directly in the control logic unit 213 itself. Alternatively, in other embodiments, the timing can be adjusted by means of a trimmer (not shown in the figure) or a dipswitch (not shown in the figure), present on the drive unit 21.

In other embodiments, the timing can also be adjusted externally, in particular by providing radio frequency reception means (Bluetooth® . . . ), integrated with the actuation unit 21, connected to said logic control unit 213. In this way, for example, by means of an external terminal, which can also be a smartphone or the like, it may be possible to adjust the unlocking timer of the actuator 22.

In still other embodiments, the timing can be specific for each tag 223 (namely, for any generic communication device system) uniquely associated with the actuator 22 used. In other words, according to the actuator (or bolt) 22 considered, the tag 223 will be different and a specific timing will be associated with it, read by the RFID reader 216, and consequently by the control logic unit 213.

Only after a specific time interval, does the logic control unit 213 pilot, by means of the actuator 214, the blocking member 215, releasing the engagement member 222, and allowing the user to open the gate of the door to allow access to the machine or the plant M.

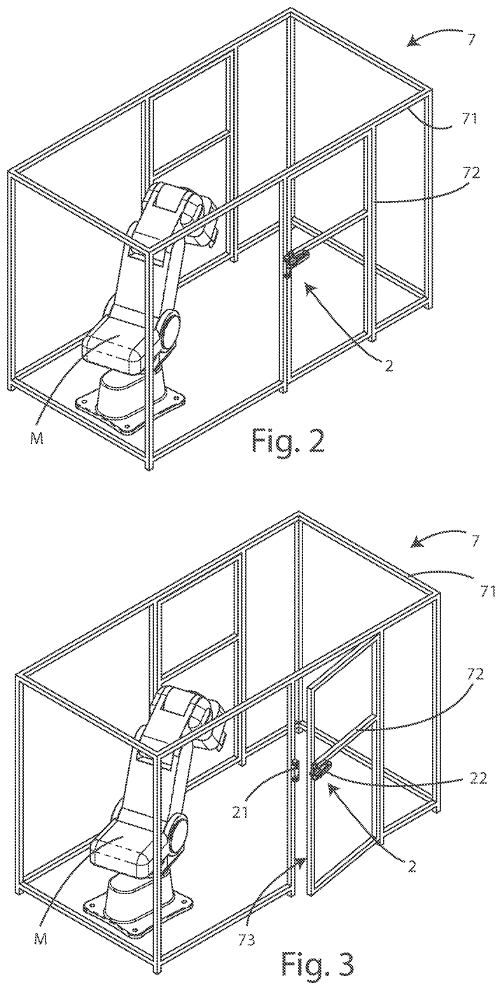

With reference now to FIGS. 2-5, an embodiment of the unlocking system 1 according to the present embodiment and its integration with a concrete application can be observed.

In particular, with reference to FIGS. 2 and 3, a protection cabin 7 can be observed, consisting of a frame 71 and a door 72 hinged to the frame 71, to close or open a gap or entrance 73. Inside the protection cabin 7 the plant M to be powered is arranged, generally illustrated as a robot.

In order for a user to enter the protection cabin, in order to access the robot (the powered system M), the door 72 must be opened.

The locking unit 2 is installed between the door 72 and the frame 71. In particular, the drive unit 21 is arranged on the frame 71, while the actuator 22 is arranged on the door 72.

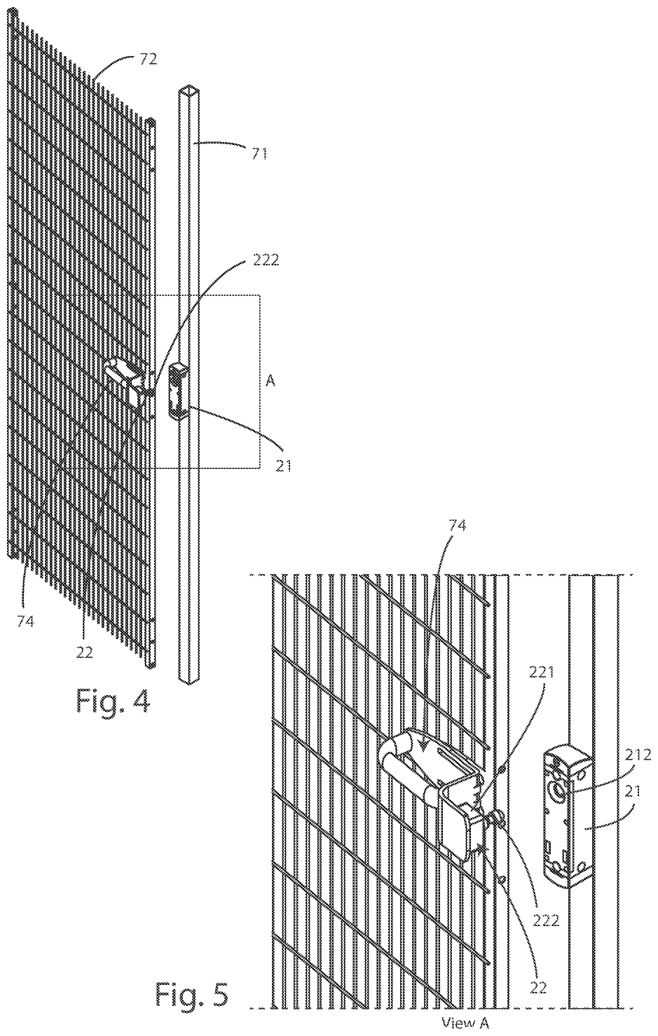

With particular reference to FIGS. 4 and 5, the arrangement of the actuation unit 21 and of the actuator 22 can be seen in particular. In particular, it can be observed that the actuation unit 21 is arranged on a jamb of the frame 71. In particular, the actuation unit is fixed to the frame 71 by means of screws.

Instead, the actuator 22 is integrated in a handle 74, installed on the door, in correspondence of the actuation unit 21, so that, when the door is closed, the engagement member 222 fits into the opening 212.

By virtue of the operation of the unlocking system 1 according to the present embodiment as described above, the actuator 22 is released, which allows, if necessary, the opening of the door 72 and the possibility for a user or maintenance technician to come in the protection cabin 7 and physically access the system M, in total safety.

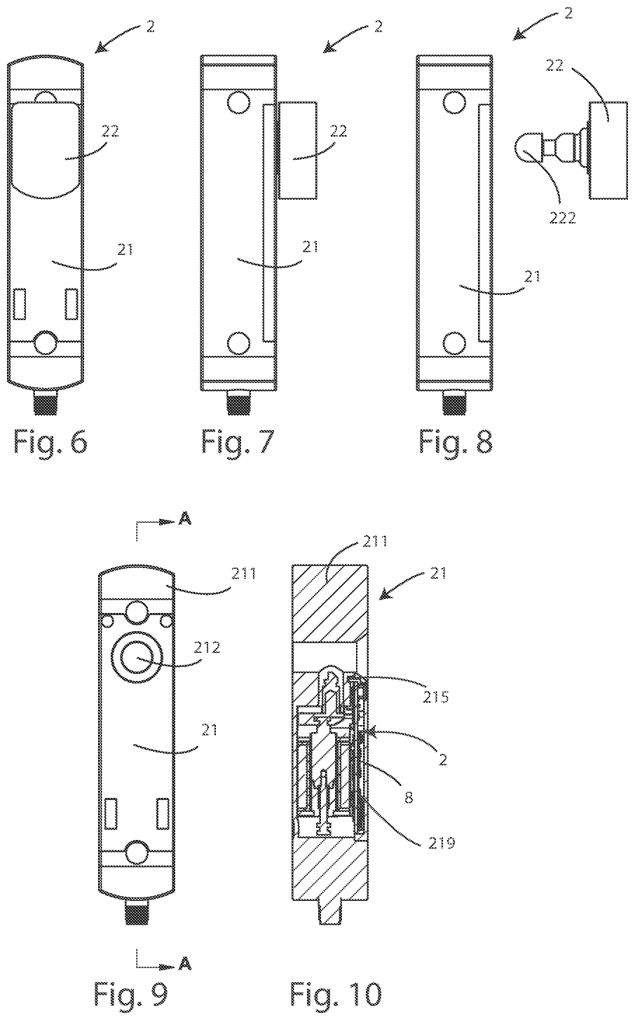

With reference now to FIGS. 6-10, the unlocking unit 2 can be observed in greater detail, which, as mentioned, comprises the actuation unit 21 and the actuator 22.

With reference in particular to FIG. 10, a section of the actuation unit 21 can be observed, in which the blocking member 215 can be distinguished, which in the case under examination is a pin, which is moved by means of the power supply of an electromagnet 219.

Furthermore, the electronic board 8, in which the control logic unit 213 is implemented is arranged at a lateral surface of the containment casing 211.

An advantage of the present embodiment is that of avoiding tampering with the bolts.

A further advantage of the present embodiment is that of being highly compact and therefore low cost.

Another advantage of the present embodiment is that it allows programmability of the safety timing.

The present disclosure has been described for illustrative but not limitative purposes, according to its preferred embodiments, but it is to be understood that modifications and/or changes can be introduced by those skilled in the art without departing from the relevant scope as defined in the enclosed claims.

What is claimed is:

1. An unlocking system for unlocking an opening of a door or gate, comprising:
at least one power supply control device, interposed between a power supply network and a load to be supplied; and
an unlocking unit, comprising:
an actuator, comprising:
a body that can be fixed to a door or gate; and
an engagement member; and
an actuation unit, which can be fixed to a frame in correspondence with an opening, closed by said door or gate, wherein said actuation unit comprises a containment containing:
a blocking member, engageable with said engagement member when said door or gate are closed; and
a logic control unit, configured to control operation of said at least one power supply control device, so as to allow an interruption of a power supply of said load, and to activate the blocking member, releasing the engagement member, after a predefined or predefined time interval.

2. The unlocking system according to claim 1, wherein
said logic control unit is connected to said blocking member to control said blocking member, and
said logic control unit is configured or configurable to allow the power supply of said load following the engagement of said blocking member with said engagement member.

3. The unlocking system according to claim 1, wherein said actuation unit comprises an actuator connected to said logic control unit, capable of driving said blocking member.

4. The unlocking system according to claim 1, wherein said power supply control device is a remote control switch, comprising:
a winding, connected to said logic control unit;
a group of switches, connected to said power supply network, to control the power supply of said load; and
a control switch or switching unit, connected to said logic control unit, by which said logic control logic unit detects a switching state of said group of switches.

5. The unlocking system according to claim 1, further comprising a first and a second remote control switch, series connected,
wherein said control switch of said first remote control switch is connected to a control power supply,
wherein said control switch of a second contactor is connected to said control logic unit,
wherein a group of switches of said first remote control switch is connected to said power supply network, and
wherein the group of switches of said second remote control switch is connected to said load.

6. The unlocking system according to
claim 1, wherein said actuation unit comprises a communication-reader device operatively connected to said logic control unit,
in that said actuator comprises an emitter device arranged in said body, so that when the engagement member is engaged with said blocking member, said emitter device is in correspondence with said communication-reader device for the communication-reader device to read said emitter device, wherein said emitter device has an identification code memorized.

7. The unlocking system according to claim 1, wherein a communication reader device comprises an RFID reader operatively connected to said logic control unit, and
an emitter device comprises a tag.

8. The unlocking system according to claim 6, wherein said communication-reader device and said emitter device are operatively connected by radio frequency, magnetic and/or optical technology.

9. The unlocking system according to claim 1, wherein said logic control unit is configured or configurable to control the operation of said at least one power supply control device, supplying said load according to an identification code of an emitter device read by a communication reader device.

10. The unlocking system according to claim 6, wherein said predefined or predefinable time interval, which is stored in said emitter device and detected by said communication-reader device.

11. The unlocking system according to claim 1, wherein said time interval of said logic control unit is programmable and/or adjustable by one or more of the following:
at least one trimmer;
a capacitive regulator;
via radio; and/or
via bus connected to said logic control unit.

12. The unlocking system according to claim 1, wherein said at least one power supply control device is integrated inside said body of said release unit.

13. An unlocking system, comprising:
an actuator, comprising:
a body, which can be fixed to a door or gate; and
an engagement member; and
an actuation unit, which can be fixed to a frame in correspondence with an opening, closed by said door or gate, comprising:
a blocking member, engageable with said engagement member when said door or gate are closed; and
a logic control unit, connectable to a power supply control device, configured to control the operation of at least one power supply control device, so as to allow an interruption of a power supply a load, and to actuate the blocking member, releasing the engagement member, after a predefined or predefined time interval.

14. The unlocking system according to claim 13, wherein said actuation unit comprises an actuator connected to said logic control unit, capable of driving said blocking member.

15. The unlocking system according to claim 13,
wherein said actuation unit comprises a communication-reader device, such as an RFID reader, functionally connected to said logic unit control, and
said actuator comprises an emitter device, arranged in said body, so that when the engaging member is engaged with said blocking member, said emitter device is located in correspondence with said RFID reader for the RFID reader to read said emitter device, wherein said emitter device has an identification code memorized.

16. An unlocking method, for controlling an unlocking system according to claim 1, comprising the steps of:
receiving an unlocking or deactivating instruction by a stop switch;
sending a signal to interrupt the power supply of the load through at least one power control device;
receiving a feedback signal that the power supply to the load has been interrupted;
starting a predefined timing; and
unlocking a door by actuating a blocking member, which disengages an engagement member of an actuator, which can be fixed to said door to be blocked.

17. The unlocking method according to claim 16, further comprising the steps of:
receiving an activation instruction by a start switch;
blocking a door by actuating a blocking member, which engages an engagement member of an actuator, which can be fixed to said door to be locked; and
sending a signal to enable the powering of the load by said at least one power control device.

18. The unlocking method according to claim 17, wherein step of locking a door by operating a blocking member takes place following the step of recognizing an identification code stored in a tag arranged in said actuator by means of an RFID reader.

19. The unlocking method according to claim 18, wherein said timing is a function of said identification code stored in said tag.

20. A computer program comprising instructions which, when the program is executed by a computer, cause the computer to execute the steps of the method according to claim 16.

21. A computer readable storage medium comprising instructions which, when executed by a computer, cause the computer to execute the method steps according to claim 16.
